(19) United States
(12) Patent Application Publication
(10) Pub. No.: US 2009/0327701 A1
(43) Pub. Date: Dec. 31, 2009

(54) ID Card Encryption

(76) Inventor: John B. Holz, Natick, MA (US)

Correspondence Address: CHARLES MANEY;NCR CORPORATION, LAW DEPT., 1700 S. PATTERSON BLVD., DAYTON, OH, 45479-0001, US

(21) Appl. No.: 12/129,887

(22) Filed: May 30, 2008

Related U.S. Application Data
(60) Provisional application No. 61/020,164, filed on Jan. 10, 2008.

(51) Int. Cl. H04L 9/32

(52) U.S. Cl. 713/155

(57) ABSTRACT

An ID card is authenticated. Encrypted data is read from a first security feature on the ID card. A value is computed based on the encrypted data. Unencrypted data is read from a second security feature on the ID card. The value and the unencrypted data is transmitted to an authentication center. An authentication message is received from the authentication center.

This application claims priority from U.S. Provisional Application Ser. No. 61/020,164, entitled “ID CARD ENCRYPTION,” which was filed on Jan. 10, 2008.

### BACKGROUND

The Department of Homeland Security (“DHS”) has proposed rules for driver's licenses or identity cards. For the purposes of this patent application the terms “driver's license,” “identity card,” and “ID card” will be used interchangeably.

Among the features proposed by DHS in its “Minimum Standards for Driver's Licenses and Identification Cards Acceptable by Federal Agencies for Official Purposes” (DHS-2006-0030 (2 Mar. 2007)) are a common set of data elements that is stored in a format acceptable for Machine Readable Technology (“MRT”). The format of the Common MRT is proposed to be PDF417 as defined in ISO/IEC 15438—Information Technology—Automatic identification and data capture techniques—Bar code symbology specifications—PDF417 (15 Sep. 2001). The Common MRT that is proposed by DHS contains the following information:

Full legal name: 125 characters encoded in PDF417

Driver's license or Identification Card Number

Expiration date

Issue date

Date of birth

Gender

Address

The Common MRT is similar to, and a proper subset of, the information required by the American Association of Motor Vehicle Administrators (“AAMVA”) in its International Specification (March 2005). While the DHS requires that the Common MRT on the front of an ID card, the AAMVA requires a two-dimensional (“2D”) barcode with information including the Common MRT information in “zone 4,” which is on the back of an ID card.

DHS further proposes that the Common MRT be encrypted for the privacy of the holder of the card. In contrast, the AAMVA International Specification assumes that the 2D barcode is unencrypted and that the authenticity of the card can established by reading the 2D barcode and comparing it to stored data.

### SUMMARY

In general, in one aspect, the invention features a method for authenticating an ID card. The method includes reading encrypted data from a first security feature on the ID card and computing a value based on the encrypted data. The method further includes reading unencrypted data from a second security feature on the ID card. The method further includes transmitting the value and the unencrypted data to an authentication center and receiving an authentication message from the authentication center.

Implementations of the invention may include one or more of the following. Reading encrypted data from a first security feature on the ID card may include reading encrypted data from an MRT. Computing a value may include computing a checksum from the encrypted data. Reading unencrypted data from a second security feature may include reading unencrypted data from a LumID seal. Reading unencrypted data from a second security feature may include reading unencrypted data from a barcode.

In general, in another aspect, the invention features a computer program, stored in a tangible medium, for authenticating an ID card. The program includes executable instructions that cause a computer to read encrypted data from a first security feature on the ID card, compute a value based on the encrypted data, read unencrypted data from a second security feature on the ID card, transmit the value and the unencrypted data to an authentication center, and receive an authentication message from the authentication center.

Implementations of the invention may include one or more of the following. Reading encrypted data from a first security feature on the ID card may include reading encrypted data from a MRT. When computing a value the computer may compute a checksum from the encrypted data. When reading unencrypted data from a second security feature the computer may read unencrypted data from a LumID seal. When reading unencrypted data from a second security feature the computer may read unencrypted data from a barcode.

In general, in another aspect, the invention features a method for storing authentication information about an ID card. The method includes receiving a value computed from encrypted data stored in a first security feature on the card, receiving unencrypted data retrieved from a second security feature on the card, using at least a portion of the unencrypted as an index to locate a row in a table, and storing the value in the row in the table.

Implementations of the invention may include one or more of the following. Receiving unencrypted data retrieved from a second security feature on the card may include receiving a card number.

In general, in another aspect, the invention features a computer program, stored in a tangible medium, for storing authentication information about an ID card. The program includes executable instructions that cause a computer to receive a value computed from encrypted data stored in a first security feature on the card, receive unencrypted data retrieved from a second security feature on the card, use at least a portion of the unencrypted as an index to locate a row in a table, and store the value in the row in the table.

Implementations of the invention may include one or more of the following. When receiving unencrypted data retrieved from a second security feature on the card, the computer may receive a card number.

In general, in another aspect, the invention features a method for authenticating an ID card. The method includes receiving a value computed from encrypted data stored in a first security feature on the card, receiving unencrypted data retrieved from a second security feature on the card, using at least a portion of the unencrypted data as an index to locate a row in a table, retrieving a stored value from the row, determining that the stored value matches the retrieved value, and in response, transmitting an authentication message.

Implementations of the invention may include one or more of the following. Using at least a portion of the unencrypted data as an index to locate the row in the table may include using all of the unencrypted data as an index to locate the row in the table. Determining that the stored value matches the retrieved value may include determining that the stored value equals the retrieved value. Determining that the stored value matches the retrieved value may include processing the stored value before determining that it matches the retrieved value. Determining that the stored value matches the retrieved value may include processing the retrieved value before determining that it matches the stored value.

In general, in one aspect, the invention features a computer program, stored in a tangible medium, for authenticating an ID card. The program includes executable instructions that cause a computer to receive a value computed from encrypted data stored in a first security feature on the card, receive unencrypted data retrieved from a second security feature on the card, use at least a portion of the unencrypted data as an index to locate a row in a table, retrieve a stored value from the row, determine that the stored value matches the retrieved value, and in response transmit an authentication message.

Implementations of the invention may include one or more of the following. When using at least a portion of the unencrypted data as an index to locate the row in the table the computer may use all of the unencrypted data as an index to locate the row in the table. When determining that the stored value matches the retrieved value the computer may determine that the stored value equals the retrieved value. When determining that the stored value matches the retrieved value the computer may process the stored value before determining that it matches the retrieved value. When determining that the stored value matched the retrieved value the computer may process the retrieved value before determining that it matches the stored value.

In general, in another aspect, the invention features a system for authenticating an ID card. The system includes a card reader to (a) read encrypted data from a first security feature on the ID card; (b) compute a value from the encrypted data; (c) read unencrypted data from a second security feature on the ID card; (d) transmit the value and the unencrypted data to an authentication center; (e) receive an authentication message from the authentication center; and (f) provide an indication that the ID card is authentic. The authentication center is configured to (a) receive the transmitted value and unencrypted data; (b) use at least a portion of the unencrypted data as an index to locate a row in a table; (c) read a retrieved value from the row; (d) determine that the retrieved value matches the received value; and (e) transmit the authentication message to the card reader.

In general, in another aspect, the invention features a method for authenticating an ID card. The method includes using a first authentication center to verify the authenticity of the ID card using encrypted data read from the ID card without decrypting the encrypted data. The method further includes decrypting the encrypted data to produce decrypted data at a second authentication center different from the first authentication center. The method further includes using the decrypted data at the second authentication center to verify the authenticity of the ID card.

Implementations of the invention may include one or more of the following. Using the first authentication center to verify the authenticity of the ID card may include reading encrypted data from a first security feature on the ID card, computing a value based on the encrypted data, reading unencrypted data from a second security feature on the ID card, transmitting the value and the unencrypted data to a first authentication center, and receiving a card-valid authentication message indicating that the ID card is valid from the first authentication center.

### BRIEF DESCRIPTION OF THE DRAWINGS

FIG. 1 illustrates a system for authenticating an ID card.

### DETAILED DESCRIPTION

There are several possible encryption scenarios that could be employed to ensure privacy in the Common MRT information:

1. LumID™ unique “seal” in combination with completely encrypted Common MRT;

2. Partially encrypted Common MRT (identification of state and driver's license number not encrypted);

3. Completely encrypted Common MRT (requiring that identification of state and driver's license number be entered manually); and

4. Completely encrypted Common MRT with an additional 2D barcode containing encrypted versions of the identification of state and driver's license number.

When the Common MRT is encrypted, verifying the authenticity of the Common MRT requires knowing the state (or other issuing jurisdiction, where a jurisdiction is another state, a territory, a country or other political division) and the driver's license or ID card number. Scenarios 2, 3, and 4 would implement such an approach. Implementing scenarios 3 and 4 may pose some operational problems in light of the AAMVA specification, which specifies all of the fields on the card.

Scenario 1 is different in that, in one embodiment, an additional covert security feature, the LumID™ seal, is added to the MRT information. In one embodiment, the LumID™ seal has the format described in co-pending application Ser. No. 12/100,058, entitled “LumID Barcode Format,” filed on Apr. 9, 2008, assigned to the assignee of this application. Generally, in one embodiment, the LumID™ seal contains:

1. A format code that specifies the format of the LumID™ seal;

2. A LumID™ unique pseudo-random code; and

3. Other fields that can be used to identify the card and/or the owner of the card.

In one embodiment, the data in the LumID™ seal is encrypted but can be decrypted by a Trusted Management System (“TMS”) no matter which state or jurisdiction issued the card with the LumID™ seal.

Multiple ways exist for implementing the LumID seal, including:

1. Spectral code, created by over (or under) printing a uniform coating on the 2D barcode; and

2. Spatial code, created by over (or under) printing a 2D barcode that can only be detected when the card is illuminated.

This approach appears to implement the AAMVA's “level three” covert feature described in the quotation from the AAMVA International Specification set out below:
DL/ID cards shall contain at least one covert level 3 security feature. The feature must have absolute consistency of characteristics, be difficult to discover, be invisible to the human eye, and require special equipment and training not commonly available in order to discover. The issuing jurisdiction must insure that information about the covert feature is not made part of public record.

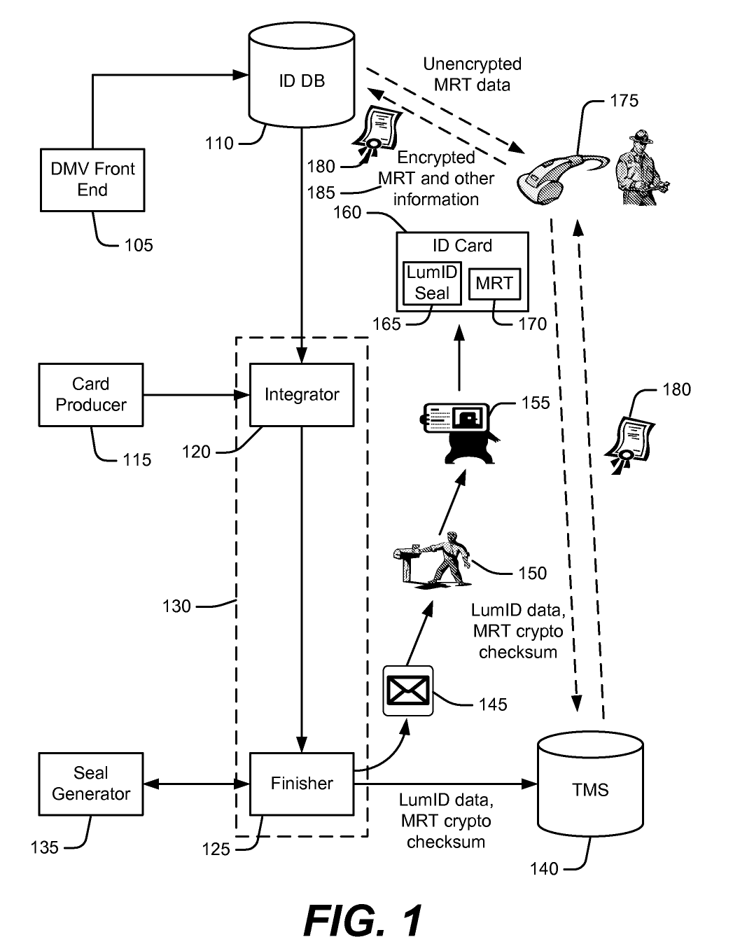

In one embodiment, as shown in FIG. 1, a front end 105 for, e.g., the Department of Motor Vehicles (“DMV”) for a particular state (or similar department from another type of jurisdiction) accepts data from an applicant for a driver's license or identity card. In one embodiment, the data covers a range of information, including, without limitation, information that could be used to create the Common MRT described above. In addition, in one embodiment, the data includes a photograph of the applicant. In one embodiment, the front end 105 stores the applicant's data in a jurisdiction ID database 110. In one embodiment, the jurisdiction ID database 110 includes a database management system (not shown) that manages interactions with the database 110. In one embodiment, there are multiple jurisdiction ID databases, each covering one or more jurisdictions.

A card producer 115 produces generic cards. In one embodiment, the generic cards are card stock with an optional magnetic stripe on the front or the back of the card. In one embodiment, the generic cards have built-in security features such as special filaments in the card that can only be detected under special light.

In one embodiment, the card stock is provided to an integrator 120, which creates an ID card for the applicant described above. To do so, in one embodiment, the integrator 120 receives the applicant's data from the ID database 110 and prints it or stores it in some manner (e.g., on the magnetic stripe) on the ID card. In particular, in one embodiment, the integrator prints the Common MRT on the ID card. In addition, in one embodiment, the integrator 120 adds additional security features, such as placing an official signature such that it overlaps the photograph.

In one embodiment, the integrator 120 delivers the ID card to a finisher 125. The integrator 120 and the finisher 125 could be the same entity as indicated by dashed box 130. In one embodiment, the finisher 125 provides a subset of the information encoded in the Common MRT to a seal generator 135, which generates a seal, such as a LumID™ seal, and delivers it back to the finisher 125. In one embodiment, the seal generator 135 receives the information necessary to create the LumID™ seal from the jurisdiction ID database 110. The finisher 125 applies the seal to the ID card.

In one embodiment, the finisher 125 includes a dual-function reader (not shown) which reads data from the just-created ID card's Common MRT and LumID™ seal. In one embodiment, a checksum is computed from the data read from the Common MRT. The data from the LumID™ seal and the checksum computed from the Common MRT are transmitted to the TMS 140, where it is stored. In one embodiment, a reader is not used. Instead the checksum is computed directly from Common MRT data provided by the integrator 130 to the finisher and the LumID™ seal data is provided by the seal generator 135 to the finisher 125.

In one embodiment, the TMS uses a portion of the data read from the LumID™ seal as an index into a transaction database to determine where to store that data and the checksum.

In one embodiment, the finisher 125 produces an ID card, which is placed in the mail 145 to the applicant. In one embodiment, the applicant, who now becomes the “card holder,” receives the ID card in the mail 150 and begins to use it 155. In one embodiment, as indicated in FIG. 1, the ID card 160 includes a LumID™ seal 165 and a Common MRT 170.

Assume that the card holder presents the card, for example, at an airport security station. In one embodiment, the authenticity of the card itself is checked. In one embodiment, this is done by accessing the TMS transaction database. In one embodiment, the TMS transaction database contains data from all jurisdictions so that it can verify the authenticity of cards from all jurisdictions. For example, if an airport security officer desires to check the authenticity of a Massachusetts driver's license at an airport in Texas, the TMS transaction database will include the data necessary to make that determination.

In one embodiment, to check the authenticity of the ID card, the LumID™ seal data and the encrypted Common MRT data is read from the ID card 160 using a dual function reader 175 at an inspection point. In one embodiment, the LumID™ seal data and the Common MRT data is encrypted and transmitted to the TMS 140, along with registration data for the dual function reader 175. In one embodiment, the TMS 140 verifies the authenticity of the reader registration and then decrypts the LumID™ seal data and computes a checksum for the Common MRT. In one embodiment, a portion of the LumID™ seal is used as an index into the TMS transaction database, which allows the stored value of the checksum to be compared with the value received from the inspection point.

In one embodiment, if there is a match, a token 180, such as a “certificate of authenticity,” that includes the identification of the issuing jurisdiction and the unique ID card number is returned to the reader at the inspection point. In one embodiment, a match requires an exact match. In one embodiment, a match can be an indirect match through links in a database, for example. In one embodiment, one or both of the values are processed before a match is attempted.

In one embodiment, the dual-function reader 175 receives the certificate 180 and displays an authenticity indicator (either by illuminating an “LED” or displaying a message in a LCD screen). In one embodiment, the operator (e.g., airport security officer) inserts his or her identification card into the reader, at which point the identity of the operator is authenticated. This could be a biometric fingerprint reader (not shown) attached or connected to the dual function reader or a “smart card” chip that is embedded into the operator's ID card. Once the operator has been authenticated, the reader system creates a “jurisdiction message” that includes the decrypted LumID authenticity token 180 (this allows the jurisdiction identity and the unique ID card number to be used to validate the data at the issuing jurisdiction), the operator authenticity token, and the original encrypted MRT information (“Encrypted MRT and other information” 185 on FIG. 1). The jurisdiction message is forwarded to the issuing jurisdiction for validation.

At the issuing jurisdiction ID database 110, the authentication tokens are checked and archived. At this point a pair wise encryption is established between the issuing jurisdiction and the reader in order to protect information flowing between these points. The MRT information is decrypted and compared to the original information in the issuing jurisdictions' ID database. If there is a match, an unencrypted version of the MRT is transmitted to the reader and is displayed on the attached LCD screen.

In one embodiment, rather than the reader sending the encrypted Common MRT to the jurisdiction ID database 110, the jurisdiction ID database sends a public key to the reader 175 to allow the reader to decrypt the Common MRT.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for authenticating an ID card, the method comprising:
reading encrypted data from a first security feature on the ID card;
computing a value based on the encrypted data;
reading unencrypted data from a second security feature on the ID card;
transmitting the value and the unencrypted data to an authentication center; and
receiving an authentication message from the authentication center.

2. The method of claim 1 wherein reading encrypted data from a first security feature on the ID card comprises reading encrypted data from an MRT.

3. The method of claim 1 wherein computing a value comprises computing a checksum from the encrypted data.

4. The method of claim 1 wherein reading unencrypted data from a second security feature comprises reading unencrypted data from a LumID seal.

5. The method of claim 1 wherein reading unencrypted data from a second security feature comprises reading unencrypted data from a barcode.

6. A computer program, stored in a tangible medium, for authenticating an ID card, the program comprising executable instructions that cause a computer to:
read encrypted data from a first security feature on the ID card;
compute a value based on the encrypted data;
read unencrypted data from a second security feature on the ID card;
transmit the value and the unencrypted data to an authentication center; and
receive an authentication message from the authentication center.

7. The computer program of claim 6 wherein reading encrypted data from a first security feature on the ID card comprises reading encrypted data from a MRT.

8. The computer program of claim 6 wherein when computing a value the computer computes a checksum from the encrypted data.

9. The computer program of claim 6 wherein when reading unencrypted data from a second security feature the computer reads unencrypted data from a LumID seal.

10. The computer program of claim 6 wherein when reading unencrypted data from a second security feature the computer reads unencrypted data from a barcode.

11. A method for storing authentication information about an ID card, the method comprising:
receiving a value computed from encrypted data stored in a first security feature on the card;
receiving unencrypted data retrieved from a second security feature on the card;
using at least a portion of the unencrypted data as an index to locate a row in a table; and
storing the value in the row in the table.

12. The method of claim 11 wherein receiving unencrypted data retrieved from a second security feature on the card comprises receiving a card number.

13. A computer program, stored in a tangible medium, for storing authentication information about an ID card, the program comprising executable instructions that cause a computer to:
receive a value computed from encrypted data stored in a first security feature on the card;
receive unencrypted data retrieved from a second security feature on the card;
use at least a portion of the unencrypted as an index to locate a row in a table; and
store the value in the row in the table.

14. The method of claim 13 wherein when receiving unencrypted data retrieved from a second security feature on the card the computer receives a card number.

15. A method for authenticating an ID card, comprising:
receiving a value computed from encrypted data stored in a first security feature on the card;
receiving unencrypted data retrieved from a second security feature on the card;
using at least a portion of the unencrypted data as an index to locate a row in a table;
retrieving a stored value from the row;
determining that the stored value matches the retrieved value; and
in response transmitting an authentication message.

16. The method of claim 15 wherein using at least a portion of the unencrypted data as an index to locate the row in the table comprises using all of the unencrypted data as an index to locate the row in the table.

17. The method of claim 15 wherein determining that the stored value matches the retrieved value comprises determining that the stored value equals the retrieved value.

18. The method of claim 15 wherein determining that the stored value matches the retrieved value comprises processing the stored value before determining that it matches the retrieved value.

19. The method of claim 15 wherein determining that the stored value matches the retrieved value comprises processing the retrieved value before determining that it matches the stored value.
